(19) United States
(12) Patent Application Publication
(10) Pub. No.: US 2013/0255717 A1
(43) Pub. Date: Oct. 3, 2013

(54) SYSTEM AND METHOD FOR CLEANING SURFACES AND COMPONENTS OF MASK AND WAFER INSPECTION SYSTEMS BASED ON THE POSITIVE COLUMN OF A GLOW DISCHARGE PLASMA

(71) Applicant: KLA-TENCOR CORPORATION, Milpitas, CA (US)

(72) Inventors: Garry Rose, Livermore, CA (US); Gildardo Delgado, Livermore, CA (US)

(73) Assignee: KLA-Tencor Corporation, Milpitas, CA (US)

(21) Appl. No.: 13/852,850

(22) Filed: Mar. 28, 2013

Related U.S. Application Data
(60) Provisional application No. 61/619,627, filed on Apr. 3, 2012.

(51) Int. Cl. B08B 7/00

(52) U.S. Cl. CPC B08B 7/0021
USPC 134/1.1; 156/345.43

(57) ABSTRACT

A system and method to clean surfaces and components of mask and wafer inspection systems based on the positive column of a glow discharge plasma are disclosed. The surface may be the surface of an optical component in a vacuum chamber or an interior wall of the vacuum chamber. A cathode and an anode may be used to generate the glow discharge plasma. The negative glow associated with the cathode may be isolated and the positive column associated with the anode may be used to clean the optical component or the interior wall of the vacuum chamber. As such, an in situ cleaning process, where the cleaning is done within the vacuum chamber, may be performed.

### CROSS REFERENCE TO RELATED APPLICATION

The present application claims priority under 35 U.S.C §119 (e)(1) to U.S. Provisional Patent Application No. 61/619,627 filed on Apr. 3, 2012 and entitled “Method of Surface Cleaning Utilizing Glow Discharge Plasmas for an EUV Reticle Inspection System and E-beam Inspection System for Masks and Wafers,” which is hereby incorporated by reference.

### FIELD

The present disclosure relates to cleaning surfaces of mask and wafer inspection systems. In some embodiments, the disclosure relates to cleaning a surface of a mask or wafer inspection system using the positive column of a glow discharge plasma.

### BACKGROUND

Conventional cleaning plasma systems and methods utilize a glow discharge plasma to clean or to modify (e.g., etch) a surface. The glow discharge plasma may be formed by electrodes (e.g., an anode and a cathode) across which a voltage is applied. Typically, the glow discharge plasma comprises a negative glow formed above the cathode and a positive column formed above the anode. The negative glow of the glow discharge plasma may produce high energy ions and the positive column of the glow discharge plasma may produce low energy ions and electrons. Since the positive column produces low energy ions and electrons, the ions and electrons are typically associated with a lower kinetic energy. As such, conventional cleaning plasma systems do not use the positive column of the glow discharge plasma and instead use the negative glow of the glow discharge plasma and the associated high energy ions to clean the surface of a material.

Cleaning a material in the negative glow has several disadvantages. For example, the high kinetic energy of the ions produced by the negative glow may result in surface roughening of a material that is placed into the negative glow. Furthermore, the negative glow tends to have a smaller working area or volume and is limited to line of sight cleaning from the cathode. As such, the negative glow should not be used for the cleaning of sensitive materials, such as optics including mirrors and lenses, as the effect of the high energy ions roughening the surface of the optics will degrade their optical properties. Furthermore, since the negative glow is limited to the line of sight from the cathode and tends to have a smaller working area, the negative glow cannot be effectively used to clean an internal surface of a chamber (e.g., the walls of a vacuum chamber).

As such, what is needed are systems and methods to clean sensitive materials, such as optics, and chambers used in mask and wafer inspection systems. For example, the positive column of the glow discharge plasma may be used to clean optical components (e.g., mirrors and lenses) and the internal walls of a chamber.

### SUMMARY

In some embodiments, an apparatus may comprise a mask or wafer inspection chamber configured to receive an electrical waveform. The chamber may further comprise an anode and a cathode associated with the chamber. The anode and cathode may be configured such that when a voltage is applied between the anode and the cathode a positive column of a glow discharge plasma forms near the anode and may be used to clean the chamber based on the electrical waveform.

In some embodiments, the chamber is a vacuum chamber that is used for mask or wafer inspection, and in some embodiments, mask or wafer inspection systems used in conjunction with an extreme ultraviolet (EUV) lithography process, ultra-high vacuum (UHV) process, or an electron beam lithography process.

In some embodiments, the cathode and anode are further configured to receive a direct current (DC) signal to generate the voltage. In the same or alternative embodiments, the cathode and the anode are inside of the chamber.

In some embodiments, the cathode is behind a barrier inside of the chamber. In alternative embodiments, the anode is inside of the chamber and the cathode is inside of a flange that is coupled to the chamber.

The apparatus may further comprise a mechanical support associated with the chamber and to hold a material comprising an optical surface to be cleaned in the positive column.

### BRIEF DESCRIPTION OF THE DRAWINGS

FIG. 1 illustrates a diagram of an example glow discharge plasma environment in accordance with some embodiments.

FIG. 2 illustrates a diagram of a positive column of a glow discharge plasma environment in accordance with some embodiments of the disclosure.

FIG. 3 illustrates a diagram of an example surface cleaning configuration based on the positive column of a glow discharge plasma in accordance with some embodiments.

FIG. 4 illustrates a diagram of an example surface cleaning configuration for a chamber based on the positive column of a glow discharge plasma in accordance with some embodiments.

FIG. 5A illustrates an example of an electron from the positive column of the glow discharge plasma interacting with contaminants on a substrate.

FIG. 5B illustrates an example of an effect of an electron from the positive column of the glow discharge plasma with contaminants on a substrate.

FIG. 6A illustrates an example of a hydrogen ion from purified gas interacting with the positive column of the glow discharge plasma and contaminants on a substrate.

FIG. 6B illustrates an example of an effect of the hydrogen ion from the purified gas on contaminants on a substrate.

FIG. 7 illustrates a flow diagram of an example method to clean a chamber in accordance with some embodiments.

### DETAILED DESCRIPTION

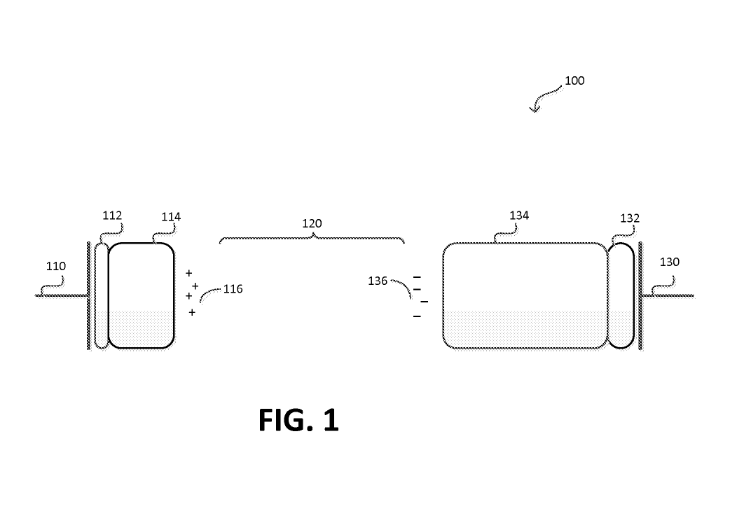

FIG. 1 illustrates a diagram of an example glow discharge plasma environment 100. In general, the glow discharge plasma environment 100 may comprise a cathode 110 with an associated cathode glow 112 and negative glow 114 and an anode 130 with an associated anode glow 132 and positive column 134.

As shown, the cathode 110 and the anode 130 may be used to generate a glow discharge plasma (e.g., comprising the negative glow 114 and the positive column 134). The glow discharge plasma may be formed by the passage of an electric current through a low-pressure and rarefied gas medium. In some embodiments, such a rarefied gas medium may be at a pressure between a tenth of a torr and 300 torr. The electric current may be created by applying a voltage between an electrode pair (e.g., the cathode 110 and the anode 130). In some embodiments, when the voltage that is applied between the electrode pair reaches a particular or threshold value, the rarefied gas medium may begin to ionize and plasma regions may form. For example, the cathode glow 112 may form adjacent to the cathode 110 and the negative glow 114 may form adjacent to the cathode glow 112 and the anode glow 132 may form adjacent to the anode 130 and the positive column 134 may form adjacent to the anode glow 132. As such, the negative glow 114 may form near or above the cathode 110 and the positive column 134 may form near or above the anode 130. A faraday dark space 120 may separate the negative glow 114 from the positive column 134.

The application of the voltage between the electrode pair may cause ionization of the atoms of the rarefied gas medium. The positively charged ions 116 may be attracted to or driven towards the cathode 110 due to its negative electric potential and the negatively charged electrons and ions 136 are attracted to or driven towards the anode 130 due to its positive electric potential. The ions 116 and electrons and ions 136 may collide with other atoms (e.g., of the rarefied gas medium) and ionize the atoms. Collisions with the ions 116 may produce high energy positively charged ions that are also attracted towards the cathode 110 while collisions with the electrons and ions 136 may produce low energy negatively charged ions and electrons that are attracted towards the anode 130. As such, since the high energy ions are attracted towards the cathode 110, the negative glow 114 may comprise a path for the high energy ions with a high kinetic energy that may result in a more aggressive or higher energy impact with the cathode 110 or an item (e.g., a substrate or a wall of a chamber) that is placed within the negative glow 114 or is bathed by the negative glow 114. Furthermore, the impact of the high energy ions on the cathode 110 may cause an ejection of material (e.g., free atoms) from the cathode (e.g., sputtering). Conversely, since the comparatively low energy ions and electrons are attracted towards the anode 130, the positive column 134 may comprise the low energy ions and electrons with a lower kinetic energy that may result in a less aggressive or lesser energy impact with the anode 130 or an item (e.g., a substrate or a wall of a chamber) that is placed within the positive column 134 or bathed by the positive column 134.

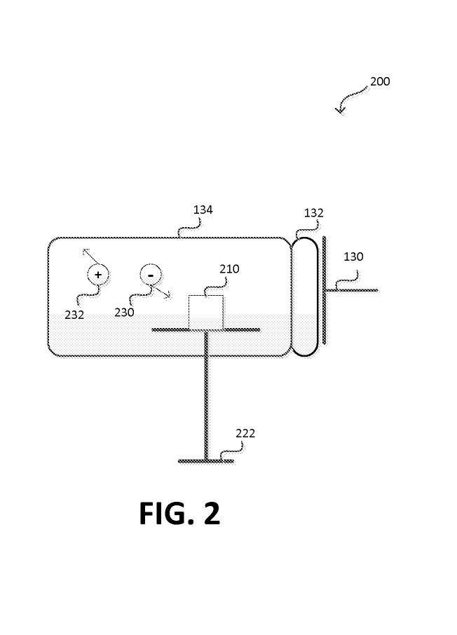

FIG. 2 illustrates a diagram of a positive column of a glow discharge plasma environment 200. In general, the positive column 134 of a glow discharge plasma may be used to clean a material 210.

As shown in FIG. 2, a material 210 may be placed within the positive column 134 that is associated with the anode 130. As previously disclosed, the positive column 134 may comprise ions and electrons with a low kinetic energy. As such, a negatively charged ion or electron 230 may be attracted towards the anode 130 and pass through the positive column 134. Since the material 210 is placed within the positive column 134, the ion or electron 230 may impact the material 210. Conversely, the positively charged ion 232 may be attracted towards a cathode and away from the anode 130. As such, the ion 232 with a higher kinetic energy may not strike or impact the material 210 in the positive column 134.

In some embodiments, the material 210 may be placed into the positive column 134 by a mechanical support 222. For example, the mechanical support 222 may hold the material 210 in the path of the positive column 134. In some embodiments, the mechanical support 222 is comprised of a conductive material. As such, if the material 210 is a conductive material or comprises a conductive surface, then an electrical signal (e.g., an electrical waveform) that is transmitted to or sent to the mechanical support 222 may also be transmitted to or sent to the material 210.

The material 210 as shown in FIG. 2 may be any type of substrate including, but not limited to, an optical substrate. For example, the material 210 may be an optical component used in mask and wafer inspection systems for extreme ultraviolet (EUV) lithography, ultra-high vacuum (UHV) applications, electron beam processing, or any application or process involving sensitive optical components. As an example, the material 210 may be a general metal surface used in electron beam processing. For example, the material 210 may comprise electron optics used in an electron beam processing chamber. In some embodiments, the material 210 may comprise a multilayer reflecting optical surface (e.g., a mirror). For example, the material 210 may be a mirror that is used in mask and wafer inspection systems used in EUV lithography applications, UHV applications, or electron beam applications and the material comprises a capping layer of reflectivity. In some embodiments, the capping layer may be a ruthenium film, platinum cap, carbon layer, or any other type of metal layer. As such, the material 210 may be a mirror with a ruthenium capping layer that is used in a mask and wafer inspection systems for an EUV, UHV, or electron beam system. In some applications of EUV, UHV, or electron beam systems, contaminants may form over time upon the ruthenium capping layer of a mirror that used in a chamber of the inspection system. For example, since ruthenium is chemically reactive and the EUV process exposes the ruthenium to gases, contaminants such as carbon based contaminants (e.g., originating from photo resist out gassing, gases used in the EUV process, etc.) and/or oxidized materials may form on a ruthenium capping layer. The formation of such contaminants upon the ruthenium capping layer may degrade the quality (e.g., reflectivity) of the mirror. As such, damage to the ruthenium capping layer may also degrade the reflectivity of the mirror and thus the operation of a mask and wafer inspection system for EUV, UHV, or electron beam processes. If the material 210 comprises a ruthenium capping layer and is placed into a negative glow (e.g., negative glow 114) of a glow discharge plasma environment, then the high kinetic energy ions (e.g., ions 232 or ions 116) will likely damage the surface of the ruthenium capping layer by removing a portion of the ruthenium layer and roughening the surface of the ruthenium, thus degrading the reflectivity of a mirror. However, if the material 210 comprises a ruthenium capping layer and is placed into the positive column 134 of the glow discharge plasma environment, then the surface of the ruthenium capping layer may not be roughened as low kinetic energy ions and electrons may instead strike the material 210. As such, contaminants that have formed on the ruthenium layer may be removed by the lower kinetic energy ions and electrons and the ruthenium capping layer may be left unchanged (e.g., not roughened) as physical sputtering of the ruthenium capping layer will not occur from the lower kinetic energy ions and electrons. Furthermore, since there is no significant sputtering associated with the anode 130, contaminants associated with the anode 130 (e.g., free atoms) do not exist or are minimized as opposed to the previously discussed sputtering associated with the cathode 110 (e.g., free atoms of the cathode that are released as a result of a high kinetic energy impact).

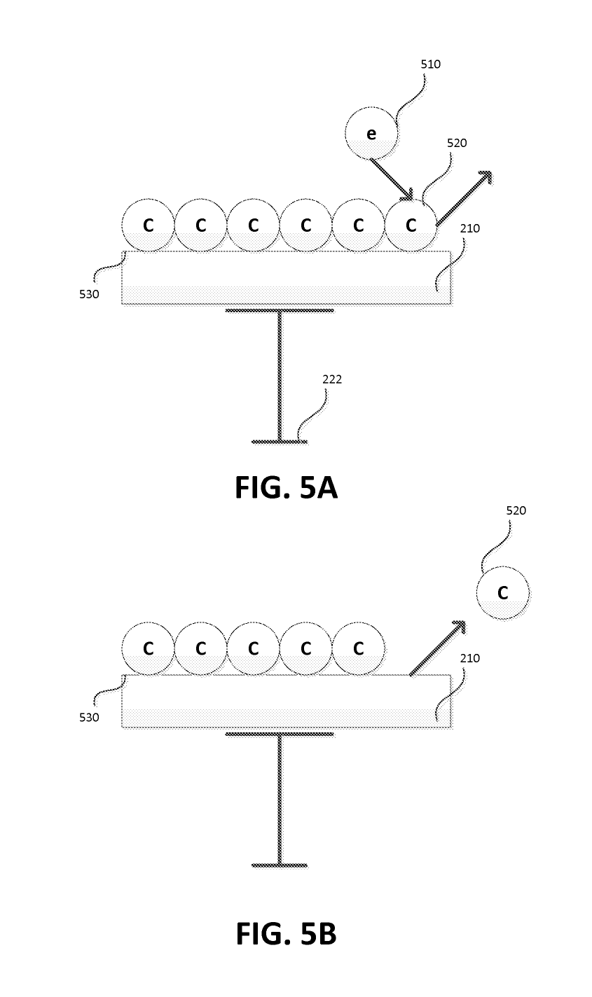

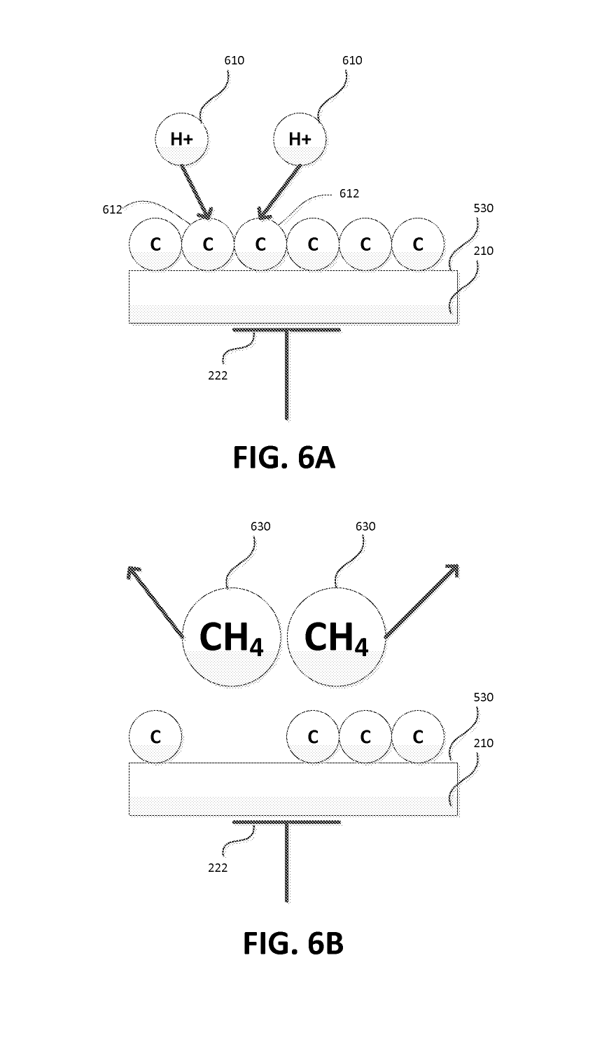

As previously disclosed, the material 210 may rest upon a conductive mechanical support 222. Furthermore, the material 210 may comprise a conductive surface (e.g., a ruthenium capping layer). In some embodiments, an electrical waveform or signal may be applied to the mechanical support 222 and subsequently to the conductive surface of the material 210. Depending upon a gas mixture that is introduced to the glow discharge plasma environment 200 and the electrical waveform or signal that is applied to the surface of the material 210, a particular type of reaction may occur at the surface of the material 210. For example, the electrical waveform may control the energy of the ions and electrons attracted towards the anode 130 and traveling through the positive column 134. Thus, the electrical waveform may determine the kinetic energy of the ions and electrons that are striking the material 210 in the positive column 134. Furthermore, a particular background gas that is introduced to the glow discharge plasma environment 200 may also react with particular contaminants on the surface of the material 210. As such, the electrical waveform and the background gas may be applied or introduced in order to drive a particular reaction or result (e.g., a chemical reaction) at the surface of the material 210. In some embodiments, the electrical waveform or signal and the background gas may be applied and introduced in order to remove carbon contaminants on a ruthenium capping layer. Further details with regard to such processes are disclosed with relation to FIGS. 5A, 5B, 6A, and 6B. Additional details with regard to using an electrical waveform or signal and background gases in general are disclosed in U.S. Pat. No. 4,031,424 entitled “Electrode Type Glow Discharge Apparatus,” U.S. Pat. No. 6,027,663 entitled “Method and Apparatus for Low Energy Electron Enhanced Etching of Substrates,” U.S. Pat. No. 6,033,587 entitled “Method and Apparatus for Low Energy Electron Enhanced Etching and Cleaning of Substrates in the Positive Column of a Plasma,” and U.S. Pat. No. 6,258,287 entitled “Method and Apparatus for Low Energy Electron Enhanced Etching of Substrates in an AC or DC Plasma Environment,” all of which are hereby incorporated by reference.

In some embodiments, the glow discharge plasma environment 200 may be part of a chamber (e.g., a vacuum chamber or other type of chamber used as part of an EUV, UHV, or electron beam system). As such, the use of the column 134 may be used in situ with relation to the mask and wafer inspection for EUV, UHV, or electron beam systems. For example, the chamber may be used to perform inspection operations associated with EUV, UHV, or electron beam processes and the cleaning of the material 210 with the positive column 134 may be performed in the same chamber. As such, a first operation of the chamber may involve the use of optical components for mask and wafer inspection associated with an EUV, UHV, electron beam, or similar processes and a second operation of the chamber may involve the cleaning steps using the positive column 134 as disclosed herein.

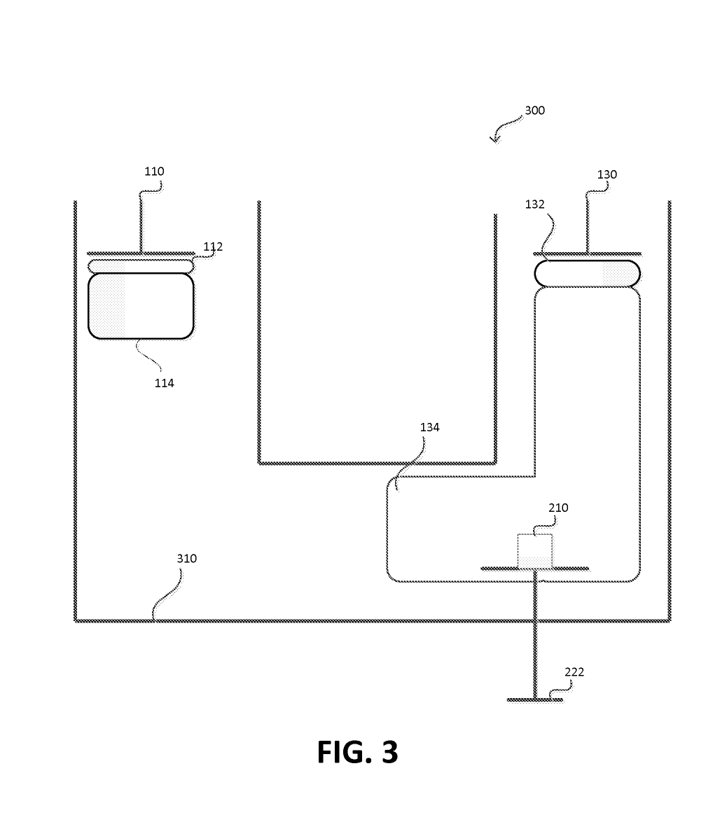

FIG. 3 illustrates a diagram of an example surface cleaning configuration 300 based on the positive column of a glow discharge plasma. In general, the configuration 300 may comprise a chamber 310 with corners or a geometry or shape such that the negative glow 114 may not interact with the material 210 while the positive column 134 may interact with the material 210.

As shown in FIG. 3, a chamber 310 may comprise corners such that the cathode 110 may be placed behind a first corner and the anode 130 may be placed behind or around a second corner. As such, the cathode glow 112 and the negative glow 114 may also form around the first corner. In some embodiments, the anode glow 132 may form around the second corner. However, the positive column 134 may bend around the second corner of the chamber 310. In some embodiments, the amount of voltage applied between the cathode 110 and the anode 130 may determine a size, area, or extent to which the positive column 134 may reach. For example, an increased voltage applied between the cathode 110 and the anode 130 may result in a larger reach for the positive column 134. Furthermore, the positive column 134 may bend around corners. As such, a particular voltage may be applied between the cathode 110 and the anode 130 in order to determine a particular reach for the positive column 134.

The material 210 may be placed the mechanical support 222 and the reach of the positive column 134 may encompass the material 210. However, the negative glow 114 may not reach or encompass the material 210. As such, lower kinetic energy ions and electrons associated with the positive column 134 may impact the material 210, but the higher kinetic energy ions associated with the negative glow 114 may be isolated from the material 210 and any sputtering from the cathode 110 (e.g., free atoms released as a result of the higher kinetic energy ions striking the cathode 110) may be isolated from material 210 by the first corner of the chamber 310. For example, such free atoms released from the cathode 110 may deposit on the walls behind the first corner near the cathode 110 instead of depositing on the material 210. In an alternative embodiment, the cathode 110 may be placed behind a barrier such that the negative glow 114 is behind the barrier and the sputtering from the cathode 110 results in deposition of material only on the walls of the barrier.

Although a particular geometry is shown for the chamber 310, any type of geometry or shape for the chamber 310 may be utilized. For example, in some embodiments, a chamber of any shape or configuration where the cathode 110 is isolated or separated from the material 210 may be used. Furthermore, the chamber 310 may be used in situ with relation to inspection systems for an EUV, UHV, or electron beam process.

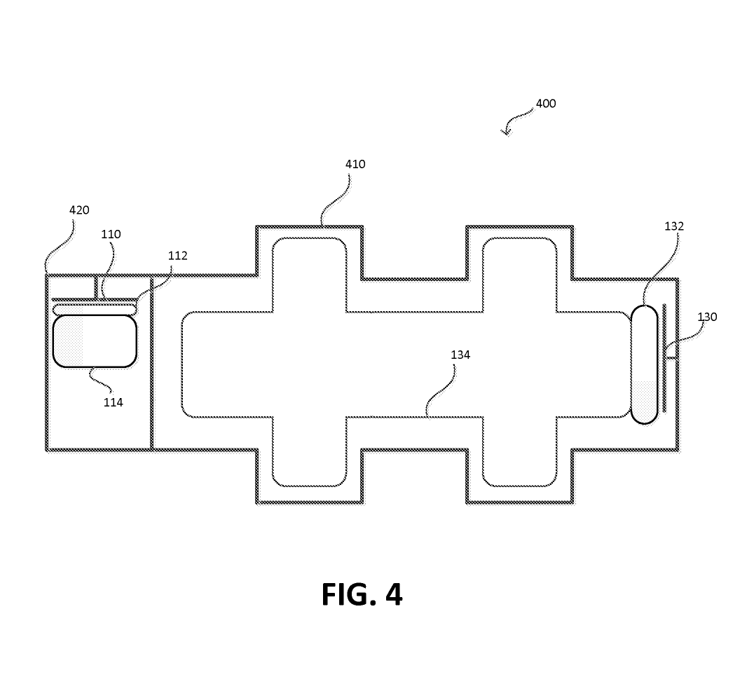

FIG. 4 illustrates a diagram of an example surface cleaning configuration 400 for a chamber 410 based on the positive column of a glow discharge plasma. In general, a positive column (e.g., positive column 134) may be used to remove contaminants from one or more walls of a chamber 410.

As shown in FIG. 4, the chamber 410 may comprise various walls and sections. Examples of the chamber 410 include, but are not limited to, a vacuum chamber, an EUV lithography chamber, a ultra high vacuum (UHV) chamber, an e-beam inspection chamber, wafer inspection chamber, or any process chamber associated with material fabrication. In some embodiments, the chamber 410 may be coupled to or comprise a flange (e.g., a vacuum flange). For example, a flange 420 may be coupled to the chamber 410 and the cathode 110 may be placed in the flange 420. Similarly, the anode 130 may be placed in a flange or may be placed in the body of the chamber 410 (e.g., affixed to a wall of the chamber). As such, the cathode glow 112 and the negative glow 114 may be isolated to the flange 420 and any sputtering of material from the cathode 110 may be limited to the area of the flange 420 and isolated from the rest of the chamber 410. As such, the flange 420 may be of a size so as to encompass or contain the entire cathode 110 and its associated cathode glow 112 and negative glow 114. Furthermore, the positive column 134 from the anode 130 may fill the space of the chamber 410 by the application of an electrical waveform or signal to the chamber 410 itself (e.g., the chamber 410 acts as an electrode). Since the positive column 134 may bend around corners, some or all of the sections of the chamber 410 (e.g., areas behind corners) may be reached by the positive column 134 depending on the electrical waveform or signal that is applied to the chamber 410. As such, the walls of the chamber 410 may be cleaned by the positive column 134 and any sputtering from the cathode 110 may be limited to the flange 420.

In some embodiments, the cathode 110 and the anode 130 may be bolted to the sides of a chamber (e.g., chamber 410). In the same or alternative embodiments, the cathode 110 and/or anode 130 may be placed onto a moving bolt coupled to the interior wall of a chamber in order to clean specific areas of the chamber. For example, the cathode 110 and/or the anode 130 may be moved from point to point around a chamber (e.g., chamber 410) by the use of the moving bolts in order to target portions of the chamber 410 to clean (e.g., interior walls) or to target components (e.g., optical components such as mirrors) that are placed in the chamber 410 as part of an EUV, UHV, or electron beam related process. As such, an in situ cleaning of the walls of the chamber 410 and/or optical components used in the chamber 410 may be performed based on the positive column 134.

Furthermore, in some embodiments, the cleaning of the walls of the chamber 410 may be aided by heating the chamber 410 with external infrared lamps or heating tapes, heated purified gas, and/or a heating cathode. A temperature range for such heating may be from an ambient temperature to a temperature of about 350 degrees Celsius.

FIG. 5A illustrates an example of an electron 510 from the positive column (e.g., positive column 134) of the glow discharge plasma interacting with contaminants on a substrate (e.g., material 210). In general, the electron 510 may be directed or attracted towards an anode (e.g., anode 130) and strike or impact contaminants that have formed on the surface of the material 210 that has been placed in the positive column. The material 210 may comprise a conductive surface 530 (e.g., a ruthenium capping layer) upon which contaminants have formed. For example, carbon atoms may have been deposited on the surface 530. An electrical waveform or signal may be applied to the mechanical support 222 and subsequently applied to the conductive surface 530. In some embodiments, the electrical waveform or signal may comprise a positive field or positive waveform. The applied waveform or signal may control the energy of the electron 510. For example, an amplitude of the positive waveform or signal may determine the energy with which the electron 510 may strike or impact the contaminants that have formed on the conducting surface 530. In some embodiments, a higher amplitude for the positive field or waveform may result in the electron 510 having a higher kinetic energy and thus striking or impacting the contaminants that have formed on the conducting surface 530 with more energy while a lower amplitude for the positive field or waveform may result in the electron 510 having a lower kinetic energy and thus striking or impacting the contaminants with less energy. The positive electric waveform or signal may be used to attract one or more electrons 510 or negatively charged ions as well as to control the kinetic energy of the electron 510 or negatively charged ion upon which the electron 510 or negatively charged ion may strike or impact the carbon contaminant 520. As such, by controlling the electrical waveform or signal that is applied at the conducting surface 530, electron 510 may be used to strike or impact the carbon contaminant 520.

FIG. 5B illustrates an example of an effect of the electron from the positive column of the glow discharge plasma with contaminants on the substrate. As shown, the chemical bonds between the carbon contaminants may have been broken by the striking or impacting of an electron (e.g., electron 510) on the carbon contaminant 520. Thus, the positive electrical waveform or signal that has been applied to the conducting surface 530 of the material 210 may be configured to attract electrons to break the bonds of carbon contaminant 520 that had formed on the conducting surface 530. For example, the positive electrical waveform or signal may be applied such that the electron may break the chemical bond of the contaminant 520 without damaging the conducting surface 530.

FIG. 6A illustrates an example of ions 610 from a background gas interacting with the positive column (e.g., positive column 134) of the glow discharge plasma on a substrate (e.g., material 210). In general, the ions 610 may be directed or attracted towards an anode (e.g., anode 130) and come into a chemical reaction with contaminants 612 that have formed on a conducting surface 530 of the material 210 that has been placed in the positive column. In some embodiments, the material 210 may be placed upon a mechanical support 222 and an electrical waveform or signal may be applied to the mechanical support 222 and subsequently to the conducting surface 530 of the material 210. The electrical waveform or signal may be a negative field or negative waveform and, as such, attract positively charged hydrogen ions 610 from a background gas that has been introduced in a chamber (e.g., chamber 310 or 410) containing the positive column. The applied electrical waveform or signal and the background gas may control a chemical reaction that takes place on the conducting surface 530. For example, the hydrogen ions 610 may be introduced as part of a background gas and the applied electrical waveform or signal may be used to attract the hydrogen ions 610 towards the conducting surface 530 and to control the kinetic energy associated with the hydrogen ions 610.

FIG. 6B illustrates an example of an effect of the ions from the background gas on contaminants that have formed on the substrate. As shown, the application of the negative electric waveform or signal and the introduction of a particular background gas may cause a specific chemical reaction to occur on the conducting surface 530. For example, a chemical reaction between the hydrogen ions 610 from the introduced background gas and carbon contaminant 612 that has formed on the conducting surface 530 of the material 210 may result in the formation of methane particles 630. In some embodiments, the methane particles 630 may then be pumped away or vacuumed out of a chamber that currently comprises the material 210. Thus, the negative electrical waveform or signal may be applied to the conducting surface 530 and the hydrogen ions 610 of a background gas that has been introduced to the chamber may be used to control a chemical reaction on the conducting surface 530 to remove the carbon contaminants 612.

The above examples disclose carbon contaminants, but the systems and methods disclosed herein may be used to remove any type of contaminant from a chamber, a wall of a chamber, a substrate, or a material. For example, the electrical waveform or signal to be applied to the conducting surface of a material may be adjusted and a particular background gas may be chosen and introduced into a chamber based on the type of contaminant that is to be removed from the conducting surface. Types of contaminants that may be removed include, but are not limited to, carbon, water, oxidation, and nanometer sized particles. Examples of a background gas that may be introduced to a chamber include, but are not limited to, Hydrogen, Oxygen, Helium, Argon, and mixtures of gases.

As such, an electrical waveform or signal may be used to control a type of particle (e.g., electron, negatively charged ion, or positively charged ion) to direct towards the conducting surface (e.g., material on a mechanical support or chamber) to which the electrical waveform or signal has been applied. Furthermore, the amplitude of the electrical waveform or signal may control the energy of the particle that is directed towards the conducting surface. As such, the electrical waveform or signal may effectively ‘tune’ a type of particle and the energy of the particle. Furthermore, particular band energies of particles may be excited by the ‘tuning’ of the electrical waveform or signal. In some embodiments, the electrical waveform may be applied by a direct current (DC) that is applied to a mechanical support, a conducting surface of a material, and/or a chamber. Thus, a DC glow discharge plasma is produced. Moreover, a background gas may be introduced to the glow discharge plasma environment in order to introduce specific types of particles to be attracted or directed towards conducting waveform or signal when the tuned electrical waveform or signal is applied.

In some embodiments, the electrical waveform or signal may be tuned at different stages to remove different types of particles or contaminants. As such, the electrical waveform or signal may be tuned to remove one type of material while leaving an adjacent material of a different type unaffected. For example, a first electrical waveform or signal may be applied to remove a first type of contaminant and, at a later point, a second electrical waveform or signal may be applied to remove a second type of contaminant. Furthermore, different types of background gases may be introduced to remove different types of material or contaminants at different stages. As such, the systems and methods herein may use a plurality of types of electrical waveforms or signals and a plurality of types of background gases to cause or initiate a plurality of reactions (e.g., a chemical reaction and/or breaking of chemical bonds) to remove a plurality of types of contaminants that have formed on a conducting surface of a material or a chamber.

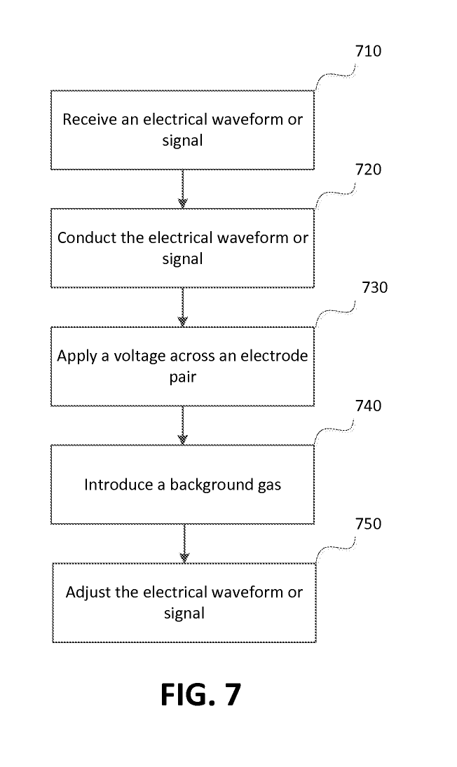

FIG. 7 illustrates an example method 700 to clean a chamber (e.g., chamber 310 or 410). In general, the method 700 may clean a chamber (e.g., the interior walls of a vacuum chamber or optical components used in the vacuum chamber) in response to an introduced background gas and/or an applied electrical waveform or signal.

As shown in FIG. 7, at step 710, an electrical waveform or signal may be received. For example, a chamber may be configured to receive the electrical waveform or signal. In some embodiments, the chamber may comprise an electrode to receive the electrical waveform or signal. In the same or alternative embodiments, the chamber may be at least partly constructed of a conducting material. For example, the interior walls of the chamber may be constructed of the conducting material. As such, in response to receiving the electrical waveform or signal, the chamber may conduct (at step 720) the electrical waveform or signal. Thus, the interior walls of the chamber may also conduct the received electrical waveform or signal. Furthermore, a voltage may be applied (at step 730) across or between an electrode pair. For example, the voltage may be applied across or between an anode and a cathode. The applying of the voltage across or between the electrode pair may result in the initiation of a glow discharge plasma comprising the negative glow near the cathode and the positive column near the anode. In some embodiments, a background gas may be introduced (at step 740) into the chamber. For example, the chamber may comprise a valve or a pump that may be used to propagate a selected type of background gas throughout the chamber. The electrical waveform or signal introduced may be adjusted (at step 750). For example, the electrical signal or waveform may be adjusted based on the type of contaminant that has been deposited on the interior walls of the chamber or based on the type of contaminant that has been deposited on optical components housed within the chamber. In some embodiments, the voltage applied between or across the electrode pair may also be adjusted. For example, the voltage may be adjusted based on the shape or geometry of the interior walls of the chamber.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the method disclosed herein, various steps are disclosed illustrating some of the functions of an embodiment. These steps are merely examples, and are not meant to be limiting in any way. Other steps and functions may be contemplated without departing from this disclosure or the scope of an embodiment.

What is claimed is:

1. An apparatus comprising:
a wafer or mask inspection chamber configured to receive an electrical waveform and to conduct the electrical waveform to conductive surfaces of the wafer or mask inspection chamber;
a source of gas associated with the wafer or mask inspection chamber;
a vacuum system associated with the wafer or mask inspection chamber;
a power system associated with the wafer or mask inspection chamber;
an anode associated with the wafer or mask inspection chamber; and
a cathode associated with the wafer or mask inspection chamber, the anode and cathode are configured such that when a voltage is applied between the anode and the cathode in a presence of the gas at vacuum conditions, a positive column of a glow discharge plasma forms near the anode and the positive column is used to clean the wafer or mask inspection chamber surfaces based on the electrical waveform.

2. The apparatus of claim 1, wherein the wafer or mask inspection chamber is further configured to be used in conjunction with an extreme ultraviolet (EUV) lithography process.

3. The apparatus of claim 1, wherein the wafer or inspection chamber is further configured to be used in conjunction with at least one of an ultra-high vacuum (UHV) process or an electron beam lithography process.

4. The apparatus of claim 1, wherein the power source comprises a direct current (DC) power source.

5. The apparatus of claim 1, wherein the cathode and the anode are inside of the wafer or mask inspection chamber.

6. The apparatus of claim 5, wherein the cathode is behind a barrier inside of the wafer or mask inspection chamber.

7. The apparatus of claim 1, wherein the conductive surfaces of the wafer or mask inspection chamber comprise interior walls and optical components.

8. A method performed in a wafer or mask inspection chamber having a source of gas, a vacuum system, an anode, a cathode, and a power system, the method comprising:
applying a voltage between the anode and the cathode in a presence of the gas at vacuum conditions to create a glow discharge plasma comprising a positive column;
conducting an electrical waveform to surfaces of the wafer or mask inspection chamber; and
cleaning the surfaces of the wafer or mask inspection chamber with the positive column, the cleaning being based on the electrical waveform.

9. The method of claim 8, wherein the wafer or mask inspection chamber is configured to be used in conjunction with an extreme ultraviolet (EUV) lithography process.

10. The method of claim 8, wherein the wafer or inspection chamber is configured to be used in conjunction with an ultra-high vacuum (UHV) process.

11. The method of claim 8, wherein the wafer or inspection chamber is configured to be used in conjunction with an electron beam lithography process.

12. The method of claim 8, wherein the surfaces of the wafer or mask inspection chamber comprise interior walls of the wafer or mask inspection chamber.

13. The method of claim 8, wherein the surfaces of the wafer or mask inspection chamber comprise optical components.

14. The method of claim 8, wherein the voltage applied between the anode and the cathode is a direct current (DC) voltage.

15. A system comprising:
a wafer or mask inspection chamber configured to conduct an electrical signal;
a source of gas associated with the wafer or mask inspection chamber;
a vacuum system associated with the wafer or mask inspection chamber;
a power system associated with the wafer or mask inspection chamber;
a first flange coupled to the wafer or mask inspection chamber and comprising an anode; and
a second flange coupled to the wafer or mask inspection chamber and comprising a cathode, the anode and cathode are configured such that when a voltage is applied across the anode and the cathode in a presence of the gas at vacuum conditions, a positive column of a plasma discharge associated with the anode cleans surfaces of the wafer or mask inspection chamber based on the electrical signal.

16. The system of claim 15, wherein the wafer or mask inspection chamber is further configured to be used in conjunction with an extreme ultraviolet (EUV) lithography process.

17. The system of claim 15, wherein a size of the second flange is based on containing a negative glow associated with the cathode.

18. The system of claim 15, wherein the surfaces of the wafer or mask inspection chamber comprise interior walls and optical components.

19. The system of claim 18, wherein the optical components are at least partly based on ruthenium.

20. The system of claim 15, wherein the electrical signal is to be adjusted based on a type of the contaminant to be removed.
